(19) United States
(12) Patent Application Publication
(10) Pub. No.: US 2014/0160498 A1
(43) Pub. Date: Jun. 12, 2014

(54) IMAGE PROCESSING APPARATUS, IMAGE FORMING APPARATUS AND METHOD

(71) Applicant: CANON KABUSHIKI KAISHA, Tokyo (JP)

(72) Inventor: Takaaki Yano, Tokyo (JP)

(73) Assignee: CANON KABUSHIKI KAISHA, Tokyo (JP)

(21) Appl. No.: 14/095,321

(22) Filed: Dec. 3, 2013

(30) Foreign Application Priority Data
Dec. 12, 2012 (JP) 2012-271742

(51) Int. Cl. G06K 15/02; G06F 3/12

(52) U.S. Cl. CPC G06K 15/027; G06F 3/1237
USPC 358/1.9

(57) ABSTRACT

In a system for printing by use of an image forming apparatus and an image processing apparatus connected thereto, calibration in the image processing apparatus may not be properly performed depending on the result of the calibration in the image forming apparatus. This leads to a problem of not being able to obtain an optimum printing result. To solve this problem, the image forming apparatus determines whether there is a need for calibration in the image processing apparatus by referring to the result of calibration therein. The image forming apparatus then sends notification to the image processing apparatus to prompt a user to perform calibration depending on the determination.

### BACKGROUND OF THE INVENTION

1. Field of the Invention

The present invention relates to a technique for performing optimum calibration in an image forming apparatus and an image processing apparatus (print server) connected to the image forming apparatus.

2. Description of the Related Art

It is well known that printing characteristics change in accordance with the installation environment of a printer (image forming apparatus). Changes in printing characteristics of a printer are mainly due to changes in temperature and humidity of the installation environment of the printer, deterioration of the printer through long-term use, and replacement of parts in the printer. These changes in the printing characteristics bring about changes in densities and colors in printed materials which lead to a problem of not being able to obtain consistent printing results. In markets such as a production market (commercial printing market) in which printed materials are provided as products, it is very important to obtain consistent printing results. In view of the above, calibration is performed to keep constant printing characteristics.

The calibration is performed to make correction to adjust printing characteristics of a printer to those of the target predefined in the printer. The printing characteristics include solid color characteristics and halftone characteristics. In calibration on the solid color characteristics, solid color density can be stabilized in an image for printing by, for example, adjusting the laser intensity and the device voltage in image formation. Meanwhile, in calibration on the halftone characteristics, halftone density can be stabilized in an image for printing by, for example, updating a tone correction look-up table (LUT) based on a test print result.

The calibration is usually performed in accordance with instructions from a user. However, the timing for performing the calibration is dependent on the user and as a result, it may not be performed at the right time. This leads to a problem, for example, that characteristic changes in the printer may be stored and an optimum printing result cannot be obtained if the calibration is not performed for a long time. To solve this problem, a technique has been proposed to manage the timing for the calibration in a printer. For example, Japanese Patent Laid-Open No. 2000-318266 discloses managing the elapsed time since last calibration and, in a case where a predetermined time has elapsed, displaying a warning to prompt a user to perform the calibration.

A printing system using a printer and a print server connected to the printer is capable of performing calibration individually in each apparatus. The calibration is performed to correct the printing characteristics of the printer in either device. However, the calibration on the print server is performed under a condition that the calibration on the printer has been performed so as to obtain higher correction precision and therefore, an appropriate effect cannot be obtained unless printing characteristics of the printer is kept in a certain condition.

As a result, even if the timing for the calibration on the print server is managed based on the elapsed time, printing characteristics of the printer can be changed once the calibration is performed on the printer. This could end up being unable to obtain an appropriately corrected print result. Also, there is a printer implementing a function of automatically correcting the printing characteristics of the printer in addition to the function of the calibration in accordance with instructions from a user at arbitrary timing. Even in the above case, printing characteristics of the printer is changed and an appropriately corrected print result may not be obtained.

### SUMMARY OF THE INVENTION

An image forming apparatus according to the present invention has a first calibration unit configured to perform first calibration. The image forming apparatus includes a determining unit configured to determine whether second calibration is needed in an image processing apparatus connected to the image forming apparatus by referring to the result of the first calibration, and a notifying unit configured to send notification to the image processing apparatus to prompt a user to perform the second calibration in accordance with the determination in the determining unit.

According to the present invention, the result of the calibration in the image forming apparatus is referred to determine whether there is a need for calibration in the image processing apparatus. If determined that there is a need for calibration in the image processing apparatus, a user is prompted to perform calibration therein.

With the above structure of the present invention, the user is prompted to perform calibration in a case where the calibration is not appropriately performed on the image processing apparatus due to change in the characteristics of the image forming apparatus. As a result, calibration can be performed in the image processing apparatus to appropriately correct the data for output.

Further features of the present invention will become apparent from the following description of exemplary embodiments (with reference to the attached drawings).

### BRIEF DESCRIPTION OF THE DRAWINGS

FIG. 1 is a schematic diagram of a printing system;

FIG. 2 is a schematic diagram of a module showing a control unit of a print server according to First Embodiment;

FIG. 3 is a schematic diagram of a module showing a control unit of a printing device according to First Embodiment;

FIG. 4 is a flow chart showing first calibration processing flow of the printing device according to First Embodiment;

FIG. 5 is a flow chart showing second calibration processing flow of the print server according to First Embodiment;

FIG. 6 is a flow chart showing processing flow in the printing device for making determination by referring to the result of the first calibration and notifying the print server of the determination according to First Embodiment;

FIG. 7 is a flow chart showing specific processing flow in the printing device for making determination by referring to the result of the first calibration according to First Embodiment;

FIG. 8 is a flow chart showing specific processing flow for sending notification based on the determination made by referring to the result of the first calibration in the printing device according to First Embodiment;

FIG. 9 is a flow chart showing processing flow of a print server according to First Embodiment;

FIGS. 10A and 10B are diagrams each illustrating generation of tone density correction data according to First Embodiment;

FIG. 11 is a diagram illustrating an example of a warning according to First Embodiment;

FIG. 12 is a diagram illustrating an example of a warning according to First Embodiment;

FIG. 13 is a schematic diagram of a module showing a control unit of a printing device according to Second Embodiment;

FIG. 14 is a flow chart showing specific processing flow in the printing device for making determination by referring to the result of the first calibration according to Second Embodiment;

FIG. 15 is a flow chart showing processing flow of a second calibration elapsed-time managing unit in the print server according to Second Embodiment;

FIG. 16 is a diagram illustrating an example of a warning according to Second Embodiment; and

FIG. 17 is a flow chart showing processing flow for making determination by referring to the result of the calibration according to Third Embodiment.

### DESCRIPTION OF THE EMBODIMENTS

Embodiments of the present invention are described below with reference to the accompanying drawings.

### First Embodiment

### <General Configuration of Printing System>

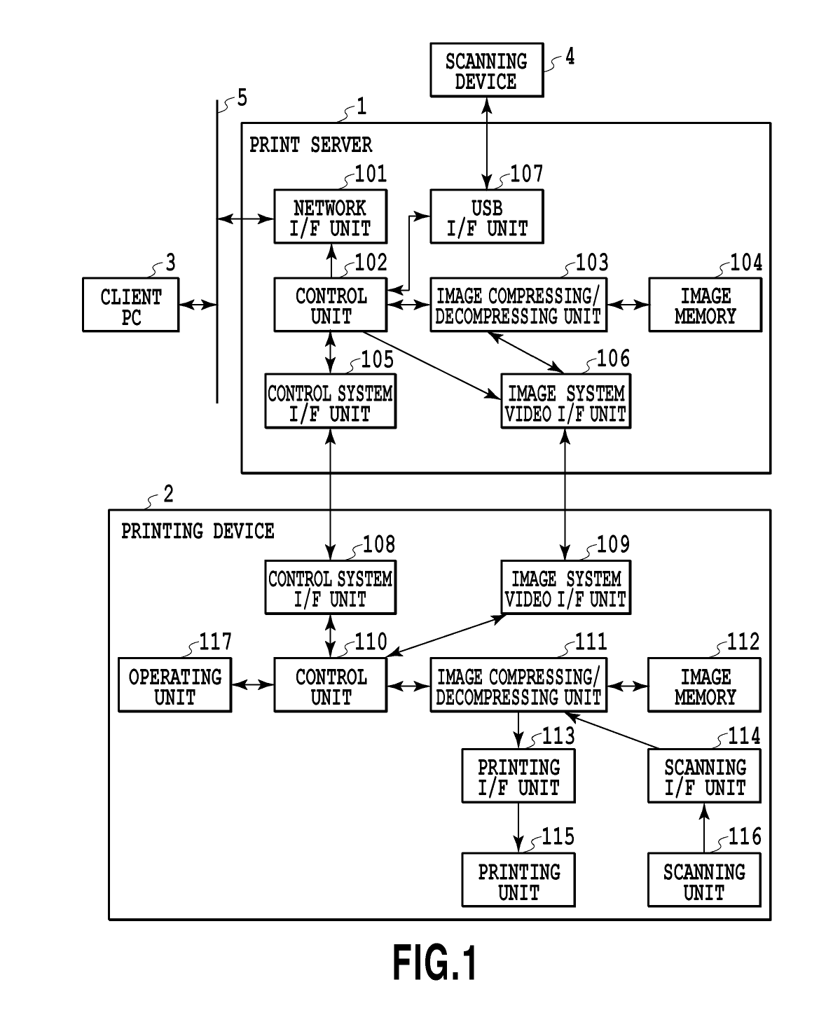

FIG. 1 is a block diagram showing an example of a printing system configuration according to the present embodiment. FIG. 1 shows that the printing system of the present embodiment includes a print server 1, a printing device 2 directly connected to the print server through a dedicated I/F unit, and a client PC 3 connected to the print server 1 through a network 5. The print server 1 of the present embodiment can be connected to an external scanning device 4 through a dedicated I/F unit such as a USB I/F unit.

The client PC 3 includes an input unit such as a keyboard and a mouse configured to enter instructions from a user, a display unit such as a display, and a PC controller configured to control general processing. Printing device managing applications are usually available on the print server 1 to be installed on the client PC3 so that the user can submit printing jobs and make various settings therefrom.

### <Configuration of Print Server>

FIG. 1 shows that the print server 1 includes a network I/F unit 101, a control unit 102, an image compressing/decompressing unit 103, an image memory 104, a control system I/F unit 105, and an image system video I/F unit 106.

The network I/F unit 101 controls communication with the client PC 3 externally connected through the network 5.

The control unit 102 includes a CPU, an HDD, and a memory, and is configured to analyze submitted printing jobs, develop the printing jobs into image data, and perform tone correction in the print server described hereinafter. The control unit 102 is also configured to transmit to the printing device 2 through the control system I/F unit 105, information required for controlling printing in the printing device 2, and to successively transmit the developed image data to the image compressing/decompressing unit 103. The control unit 102 is further configured to control calibration for updating a look-up table (LUT) used for tone correction.

The image compressing/decompressing unit 103 is configured to compress the image data developed at the control unit 102 if required and to store the compressed image data in the image memory 104. The image data stored in the image memory 104 is then decompressed and transmitted to the printing device 2 through the image system video I/F unit 106.

### <Configuration of Printing Device>

The printing device 2 includes a printing unit 115, a scanning unit 116, an operating unit 117, a control system I/F unit 108, an image system video I/F unit 109, a control unit 110, an image compressing/decompressing unit 111, an image memory 112, a printing I/F unit 113, and a scanning I/F unit 114.

The control system I/F unit 108 is configured to transmit/receive to and from the control system I/F unit 105 in the print server 1, control information related to printing jobs.

The image system video I/F unit 109 is configured to transmit/receive image data to and from the image system video I/F unit 106 in the print server 1.

The control unit 110 includes a CPU, an HDD, and a memory, and is configured to receive data from the control system I/F unit 108 and the image system video I/F unit 109 to have converted into data which can be output from the printing unit 115. The control unit 110 is also configured to process the image data transmitted from the image system video I/F unit 109 based on the control information transmitted from the control system I/F unit 108 and the setting information stored in the printing device, and to transmit the image data to the image compressing/decompressing unit 111. The control unit 110 is further configured to perform tone correction described hereinafter. Furthermore, the control unit 110 is configured to control calibration in the printing device for adjusting printing characteristics of the printing device to those of the target described hereinafter.

The image compressing/decompressing unit 111 is configured to compress the image data transmitted from the control unit 110 if required and to store the compressed image data in the image memory 112. The image data stored in the image memory 112 is then decompressed to be transmitted to the printing I/F unit.

The printing I/F unit 113 is connected to the printing unit 115 and is configured to transmit image data to the printing unit 115.

The scanning I/F unit 114 is connected to the scanning unit 116 and is configured to transmit the image data scanned at the scanning unit 116 to the image compressing/decompressing unit 111.

The operating unit 117 has an input unit configured to input print settings and instructions to perform calibration entered by a user, and a display unit configured to display information to the user. Further, the operating unit 117 is connected to the control unit 110. The control unit 110 is configured to perform processing required in accordance with the information transmitted from the operating unit 117 and to transmit to the operating unit 117 the information which needs to be displayed to the user.

### <Configuration of Control Unit in Print Server>

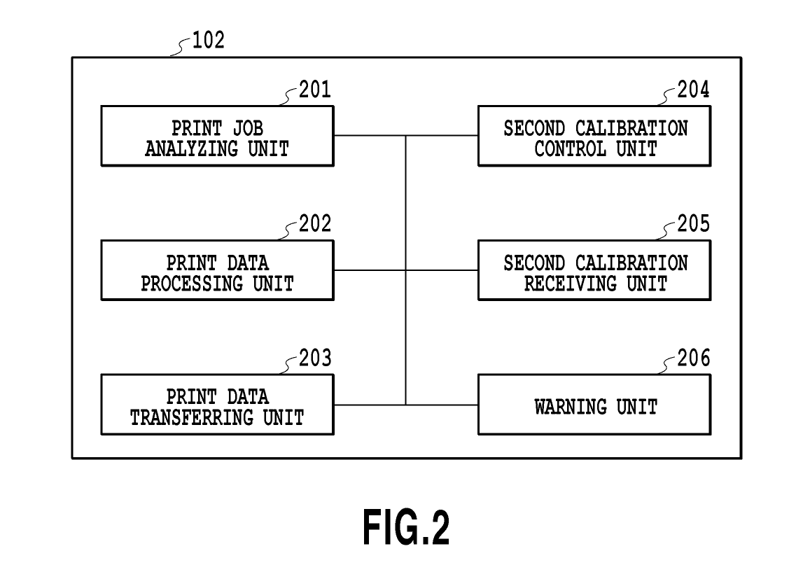

FIG. 2 is a block diagram showing a software module configuration of the control unit 102 in the print server 1 according to the present embodiment. The software module of the control unit 102 is usually stored in the HDD of the control unit 102 and read out on the memory if required to be processed by the CPU. Further, the software module of the control unit 102 includes a print job analyzing unit 201, a print data processing unit 202, a print data transferring unit 203, a second calibration control unit 204, a second calibration receiving unit 205, and a warning unit 206.

The print job analyzing unit 201 is configured to receive printing instructions of a user from the client PC 3 through the network I/F unit 101, analyze the printing jobs, and read out the print setting information included in the printing jobs. The print setting information is mainly information about settings of paper sheets used for printing, settings related to image processing for outputting print data in accordance with user preferences, settings related to image function such as printing profiles, and print finishing processing.

The print data processing unit 202 is configured to perform print data processing required at the print server in accordance with each setting read out by the print job analyzing unit 201. For example, the print data processing unit 202 is configured to use the tone correction LUT generated by the second calibration control unit described hereinafter to perform tone correction.

The print data transferring unit 203 is configured to transfer to the printing device 2, the print data processed in the print data processing unit 202. The image data is transmitted to the printing device 2 through the image compressing/decompressing unit 103, the image memory 104, and the image system video I/F unit 106. Meanwhile, the control information for print processing is transmitted to the printing device 2 through the control system I/F unit 105.

The second calibration control unit 204 is configured to control calibration (second calibration) in the print server 1 and to generate a tone correction LUT. The second calibration will be described in greater detail below.

The second calibration receiving unit 205 is configured to receive from the printing device 2, notification indicating a need for second calibration. The warning unit 206 is configured to give a warning which prompts a user to perform the second calibration, as will be described in greater detail below.

### <Configuration of Control Unit in Printing Device>

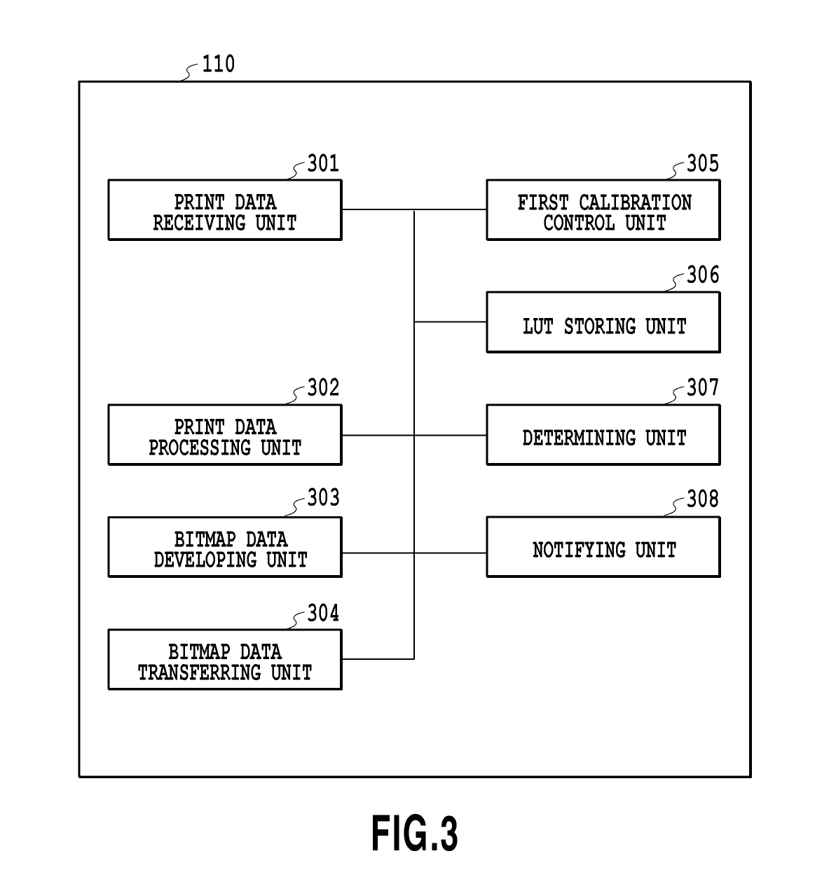

FIG. 3 is a block diagram showing a software module configuration of the control unit 110 in the printing device 2 according to the present embodiment. The software module of the control unit 110 is usually stored in the HDD of the control unit 110 and read out on the memory if required to be processed by the CPU. The software module of the control unit 110 includes a print data receiving unit 301, a print data processing unit 302, a bitmap data developing unit 303, a bitmap data transferring unit 304, a first calibration control unit 305, an LUT storing unit 306, a determining unit 307, and a notifying unit 308.

The print data receiving unit 301 is configured to receive from the print server 1, printing jobs including print data through the control system I/F unit 108 and the image system video I/F unit 109.

The print data processing unit 302 is configured to perform print processing required at the printing device. For example, the print data processing unit 302 is configured to use the tone correction LUT generated by the first calibration control unit described hereinafter to perform tone correction processing.

The bitmap data developing unit 303 is configured to develop print data processed in the print data processing unit 302 to bitmap data which can be printed on the printing device.

The bitmap data transferring unit 304 is configured to transfer to the printing unit 115, the print data developed in the bitmap data developing unit 303. The print data is transferred to the printing unit 115 from the control unit 110 through the image compressing/decompressing unit 111, the image memory 112, and the printing I/F unit 113 for print processing.

The first calibration control unit 305 is configured to control calibration (first calibration) in the printing device 2 and to generate a tone correction LUT (result of the first calibration). The first calibration will be described in greater detail below.

The LUT storing unit 306 is configured to store the tone correction LUT generated by the first calibration control unit 305. The tone correction LUT is used in the print data processing unit 302 for tone density correction. The LUT storing unit 306 is further configured to store a reference tone correction LUT used to make determination based on the result of the first calibration described hereinafter.

The determining unit 307 is configured to compare the tone correction LUT currently generated by the first calibration control unit 305 with the reference tone correction LUT stored in the LUT storing unit 306 so as to determine whether there is a need to perform second calibration. The reference tone correction LUT used for making the determination is the tone correction LUT previously generated by the first calibration control unit 305. After making the determination, the tone correction LUT currently generated by the first calibration control unit 305 is used to update the reference tone correction LUT. The updated reference tone correction LUT is used for making the subsequent determination based on the first calibration result.

In a preferred embodiment, the reference tone correction LUT used for making the determination is the tone correction LUT generated through the first calibration where a need for the second calibration is previously determined. In such an embodiment, the tone correction LUT generated by the first calibration control unit 305 may be used to update the reference tone correction LUT in the LUT storing unit 306 only in a case where the second calibration is determined to be necessary. The updated reference tone correction LUT is the tone correction LUT at the printing device which is the one used at the time of the current second calibration, and is used for making the subsequent determination based on the first calibration result.

The notifying unit 308 is configured to notify the printing device 2 of the result determined in the determining unit 307 if required. These processing will be described in greater detail below.

### <First Calibration in Printing Device>

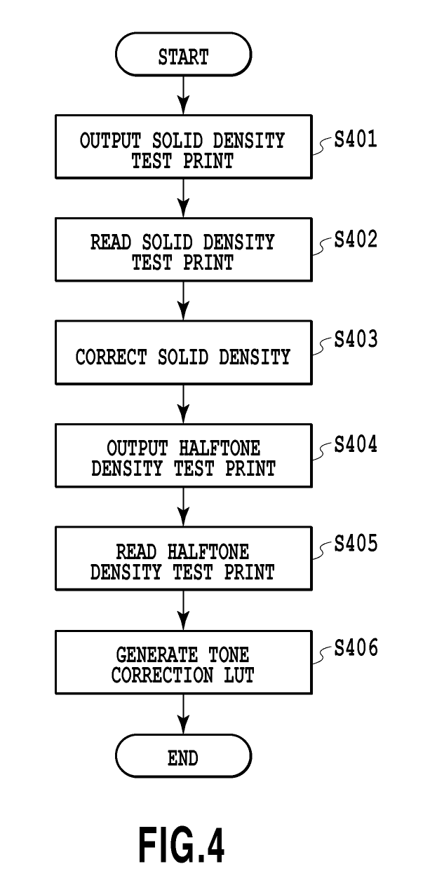

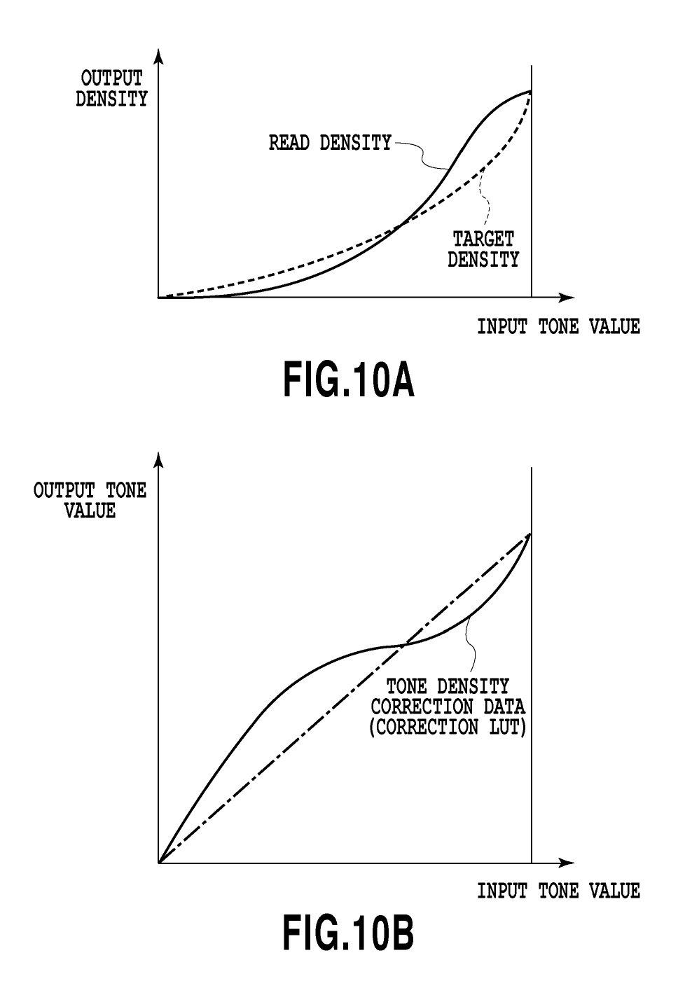

The first calibration in the printing device 2 will now be described with reference to FIGS. 4, 10A, and 10B.

FIG. 4 is a flow chart showing processing flow of first calibration. The first calibration is performed at the first calibration control unit 305 in the printing device 2. The first calibration begins by a user pressing a “calibration” button on the operating unit 117 of the printing device 2.

In step S401, the user presses a “solid density test print” button, thereby allowing the first calibration control unit 305 to output a solid density test print. In particular, the information on the solid density test print is transmitted from the operating unit 117 to the control unit 110, and then, the image data of density test print is outputted from the printing unit 115 through the image compressing/decompressing unit 111 and the printing I/F unit 113. The image data of the density test print is a chart which has a patch with maximum solid (8-bit input data representing 255) of four-color toner (cyan, magenta, yellow, black) used at the printing device printed thereon.

In step S402, the first calibration control unit 305 scans the chart outputted in step S401 with the scanning unit 116 connected to the printing device 2. The user places the outputted chart on the scanning unit 116 and presses a “scan” button on the operating unit 117, thereby allowing the scanning unit 116 to optically scan the chart to convert it into digital data. Also, the scanning I/F unit 114 transmits the scanned data to the control unit 110 through the image compressing/decompressing unit 111. The unit for scanning the chart is not limited to the scanning unit 116 and a sensor for scanning color data or density in the printing device can also be used in the printing device if it is mounted thereon.

Further, in step S403, the first calibration control unit 305 obtains from the test chart scanned by the scanning unit 116, the current maximum density (solid density) outputted from the printing device. The first calibration control unit 305 then corrects the obtained solid density so that it can be adjusted to a solid density target of the printing device previously stored in the printing device 2. This correction can be carried out, for example, by adjusting the intensity of a laser which is a part of the printing unit 115.

Next, in step S404, the user presses a “halftone density test print” button, thereby allowing the first calibration control unit 305 to output a halftone density test print. The information on the halftone density test print is transmitted from the operating unit 117 to the control unit 110, and then, the image data of the halftone density test print is outputted from the printing unit 115 through the image compressing/decompressing unit 111 and the printing I/F unit 113. The image data of the halftone density test print corresponds to a chart which has a patch with aligned tone data of a four-color toner printed thereon.

In step S405, the first calibration control unit 305 uses the scanning unit 116 connected to the printing device 2 to scan the chart outputted in step S404 by following the same procedure as the aforementioned procedure for scanning the image data of a solid density test print. The unit for scanning the chart is not limited to the scanning unit 116 and a sensor for scanning color data or density in the printing device can also be used in the printing device if it is mounted thereon.

In step S406, the first calibration control unit 305 allows the tone density characteristics of a printing device engine obtained from the chart scanned in step S405 to be corrected to the tone density characteristic target of the printing device engine prestored in the printing device 2. In particular, an LUT is generated in such a way that the output of density against the digital input tone value is adjusted to the tone density characteristic target. The generated LUT is then used in the data processing for correcting the input tone value in the print data processing unit 302 at the printing device upon execution of printing jobs.

FIG. 10A illustrates an example showing the relationship between the density data scanned in step S405 and the target density (target value) for each input tone value. In FIG. 10A, the broken-line curve represents data of tone density target showing the target density (target value) in each input tone value. In contrast, the solid-line curve represents tone density characteristics of the printing device engine in scanning of the density data in step S405.

FIG. 10B illustrates an example showing the relationship between input and output signal values (input and output tone values) processed in step S406. This relationship shown in FIG. 10B can be used as a tone correction LUT to correct tone values in such a way that the tone value of the target density can be obtained for each input tone value. The 45-degree dashed-dotted line in FIG. 10B is a reference line showing the values without tone correction.

### <Second Calibration in Print Server>

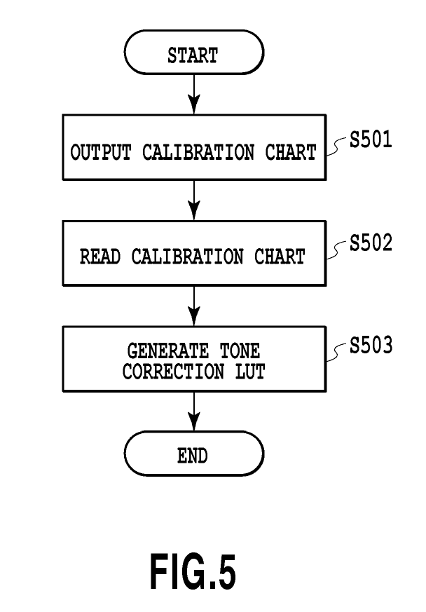

The second calibration in the print server 1 will now be described with reference to FIG. 5. FIG. 5 is a flow chart showing processing flow of the second calibration. The second calibration is controlled by the second calibration control unit 204 in the print server 1 to be performed by using both the print server 1 and the printing device 2. The second calibration begins by a user clicking a “calibration” button on the operating unit (not shown) of the client PC 3.

In step S501, the user clicks a “calibration chart output” button, thereby allowing the second calibration control unit 204 to transfer the print data of a calibration chart to the printing device 2. The transferred print data is then printed out by the printing device 2. In other words, information on the calibration chart is transmitted to the control unit 102 from the client PC through the network I/F unit 101. Next, the image data of the calibration chart stored in the print server 1 is transmitted to the printing device 2 through the image compressing/decompressing unit 103 and the image system video I/F unit 106. Further, in the printing device 2, the image data of the calibration chart received at the control unit 110 through the image system video I/F unit 109 is transmitted to the printing unit 115 through the image compressing/decompressing unit 111 and the printing I/F unit 113 to be outputted. The calibration chart is a chart which has a patch with aligned tone data including maximum solid of a four-color toner printed thereon.

In step S502, the second calibration control unit 204 scans the calibration chart outputted in step S501 with the scanning device 4 connected to the print server 1. The scanning device 4 used herein can be, for example, a colorimeter capable of measuring densities of a printed material. The density information of the outputted calibration chart is transmitted from the scanning device 4 operated by the user to the control unit 102 through a USB I/F unit 107.

Alternatively, the scanning unit 116 connected to the printing device 2 can be used to scan the density data to be transmitted to the print server 1. In such a case, the user places the calibration chart on the scanning unit 116 of the printing device 2 and presses a “scan” button of the operating unit 117 for the calibration chart to be scanned by the scanning unit 116. This allows the scanning unit 116 to optically scan the chart to be converted into digital data. The data scanned by the scanning I/F unit 114, the image compressing/decompressing unit 111, and the control unit 110 is transmitted to the print server 1 through the control system I/F unit 108. In the print server 1, data is transmitted to the control unit 102 through the control system I/F unit 105.

In step S503, the second calibration control unit 204 allows the tone density characteristics of a printing device engine obtained from the chart scanned in step S502 to be corrected to the tone density characteristic target of the print server prestored in the print server. In particular, an LUT is generated in such a way that the output of density against the digital input tone value is adjusted to the tone density characteristic target. The generated LUT is then used in the data processing for correcting the input tone value in the print data processing unit 202 at the print server upon execution of printing jobs.

The difference between the first calibration performed on the printing device and the second calibration performed on the print server will now be described. Both the first and the second calibration are directed to detect the current characteristics of the printing device engine to correct the data to output the target data, and to ensure the consistent output of printed materials. Meanwhile, the first and the second calibration are different in their target tone data and underlying requirements.

The first calibration is calibration performed on a printing device. Manufacturers of printing device engines specify maximum density of a target engine and tone target data based on their own design concept. It is well known to adopt targets such as tones for linearly changing densities and tones for linearly changing brightness. Also, the first calibration can be applied to any printing jobs including printing from a print server, printing from a printing device driver without an intervening print server, and output from printing apparatuses such as a copier and a fax machine.

The second calibration is calibration performed on a print server. Unlike the first calibration, manufacturers of print servers specify density and tone target data based on their own design concept. The second calibration is applied only to printing jobs received from the print server, and therefore the target is not required to be the same as that of the first calibration. It is noteworthy that, printing jobs received from the print server are applied to the second calibration upon print data processing in the print server, and further, the first calibration upon print data processing in the printing device after transfer of the data to the printing device. The calibration chart outputted in step S501 is outputted under condition where the first calibration is performed. That is, the condition of the engine including the corrected result of the first calibration needs to be constant as an underlying requirement for the second calibration. In other words, even if it is immediately after the correction in the second calibration, accuracy in the correction of the second calibration may be reduced if the first calibration is subsequently performed and a change in the engine characteristics is caused due to the correction in the printing device.

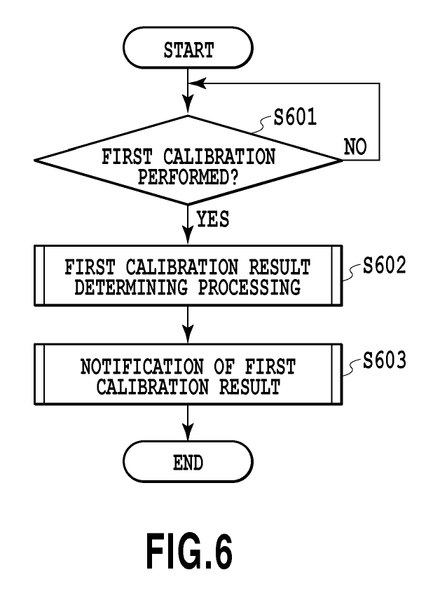

In the present embodiment, determination is made as to whether there is a need for the second calibration based on the result of the first calibration and a system for warning a user is constructed. The system of the present embodiment will be described in greater detail below with reference to FIGS. 6 to 9, 11, and 12.

### <Determination Based on First Calibration Result and Notification Thereof>

FIG. 6 is a flow chart showing processing flow for making determination based on the first calibration in the printing device 2 and sending notification of the result of the determination according to the present embodiment.

First, in step S601, the determining unit 307 determines whether the printing device 2 has performed the first calibration. If determined that the first calibration has been performed (YES in step S601), then the processing proceeds to the next step S602. If not (NO in step S601), the processing returns to the top of the flow chart.

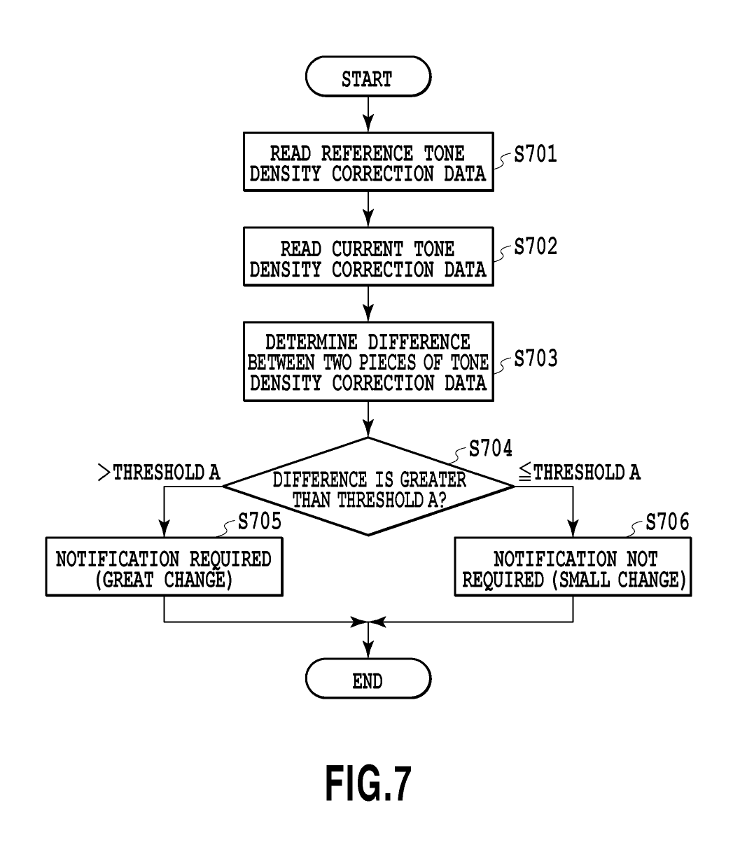

If determined in step S601 that the first calibration has been performed, the determining unit 307 determines in the following step S602 whether there is a need to perform the second calibration based on the result of the first calibration. This determination can be made by comparing the tone correction LUT currently generated by the first calibration control unit 305 with a reference tone correction LUT stored in the LUT storing unit 306. If determination is made that there is a need to perform the second calibration, the LUT storing unit 306 stores the tone correction LUT generated by the first calibration control unit 305 as a reference tone correction LUT to be used for making the subsequent determination based on the first calibration result. The determination in step S602 will be described in greater detail below with reference to FIG. 7.

Next, in step S603, the notifying unit 308 gives notification to the print server 1 based on the result determined in step S602. The notification information is transmitted from the control unit 110 in the printing device 2 to the control unit 102 in the print server 1 through the control system I/F units 108 and 105.

Step S602 for making determination based on the result of the first calibration will now be described in detail with reference to FIG. 7. This processing is performed on the determining unit 307.

First, in step S701, the determining unit 307 reads the reference tone correction LUT stored in the LUT storing unit.

Next, in step S702, the determining unit 307 reads the tone density correction data generated through the currently performed first calibration, i.e., a tone correction LUT.

Then, in step S703, the determining unit 307 obtains difference between two pieces of tone density correction data. The difference herein can be any value as long as the relative difference between the two pieces of tone density correction data is clarified, and the difference can be obtained in any way. The difference between two pieces of tone density correction data can be obtained by, for example, a method for obtaining a total amount of difference between each output value in one piece of tone density data and each output value in other piece of tone density data corresponding to each input signal value, respectively. It is also effective to adopt a method for increasing the effect of a certain area such as a highlighted area by weighting a difference value in accordance with the tone density. This is because a change in the characteristics of the highlighted area can be easier to be sensed by the human eye compared to a change in a shadow area.

Subsequently, in step S704, the determining unit 307 compares whether the difference obtained in step S703 is larger than the preset threshold.

The threshold herein is represented by threshold A. In a case where the difference is greater than the threshold A (YES in step S704), the tone correction LUT updated through the current first calibration is greatly changed from the reference tone correction LUT. As a result, the second calibration is determined to be necessary and the processing proceeds to step S705 to determine that notification to the print server 1 is necessary.

Meanwhile, in a case where the difference is smaller than the threshold A (NO in step S704), the tone correction LUT updated through the first calibration has almost no change compared to the reference tone correction LUT. As a result, the second calibration is determined to be unnecessary and the processing proceeds to step S706 to determine that notification to the print server 1 is unnecessary.

The magnitude of the threshold A is preset if required. For example, it may be difficult for a user to get the timing of density correction processing automatically performed on the printing device, and densities do not usually change greatly in such correction processing. Accordingly, the threshold A is set to determine that notification is unnecessary upon such correction in order to avoid unnecessary warnings to the user.

The reason for determining a need for performing the second calibration in accordance with the difference obtained through the first calibration will now be explained. The first calibration is performed to make correction in such a way that the printing device engine outputs data to be adjusted to the target engine characteristics. In view of the above, it may seem as if there is no need to perform the second calibration as long as the first calibration is performed. However, only tone density of monochrome of each toner can be corrected in the first calibration. A typical color printing device outputs data by overlapping plurality of toners in a halftone dot pattern, thereby allowing pseudo-representation of various colors. Even if tone density of each toner is corrected to be adjusted to the target density, the color represented with a plurality of toners is less likely to be the same as the color of the target if the printing device characteristics before the correction have greatly changed from the previous characteristics. A great difference between two pieces of tone density correction data indicates that the engine characteristics have greatly changed by the correction. As a result, the second calibration can be determined to be necessary.

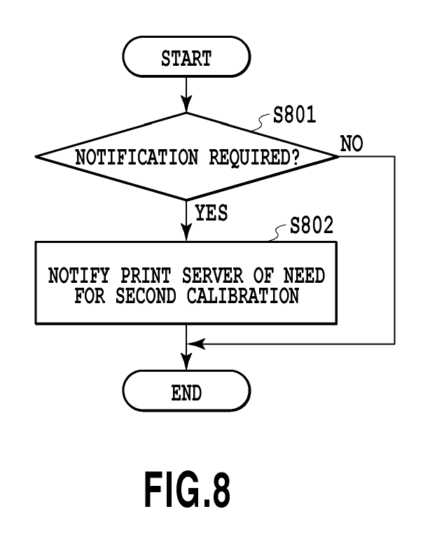

FIG. 8 is a flow chart showing processing flow of step S603 for notification. The notification made by the notifying unit 308 in the printing device 2 is transmitted to the print server 1 based on the determination made in step S602 as to whether there is a need for notification.

First, in step S801, the notifying unit 308 checks the result of the determination whether the notification of the determination made in step S602 is necessary. If determined that the notification is necessary (YES in step S801), the processing proceeds to the next step S802. If not (NO in step S801), the processing is terminated.

In step S802, the notifying unit 308 gives notification from the printing device 2 to the print server 1 that the second calibration is necessary (instructions to perform the second calibration). The information on the notification is transmitted from the control unit 110 in the printing device 2 to the control unit 102 in the print server 1 through the control system I/F units 108 and 105.

### <Warning on Second Calibration>

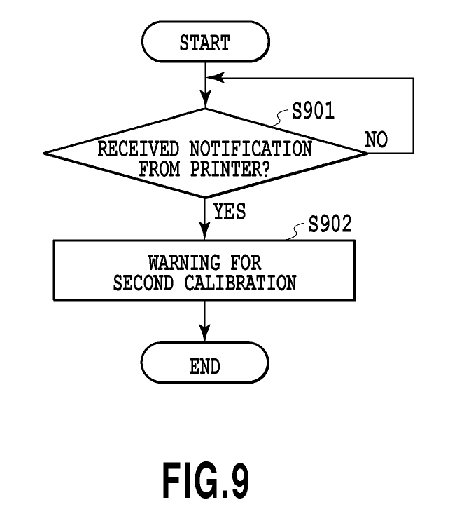

The processing of the print server 1 will now be described. FIG. 9 is a flow chart showing processing flow of the print server 1. This processing is carried out by the second calibration receiving unit 205 and the warning unit 206 in the print server 1.

First, in step S901, the second calibration receiving unit 205 determines whether notification indicating a need for the second calibration is received from the printing device 2. If determined that notification indicating a need for the second calibration is received (YES in step S901), the processing proceeds to the next step S902. If not (NO in step S901), the processing returns to the top of the flow chart.

In step S902, the warning unit 206 gives a warning which prompts a user to perform the second calibration. The warning is given from the control unit 102 and a warning screen is displayed on the display unit of the client PC 3 through the network I/F unit 101. A printing device managing application installed on the client PC3 can be used, for example, for displaying the warning screen.

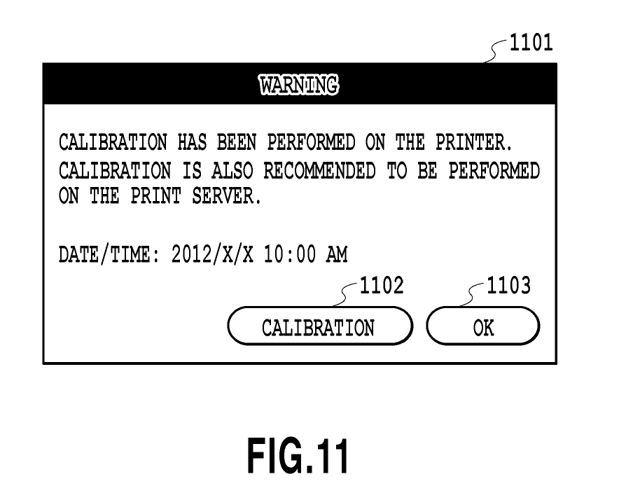

FIG. 11 illustrates an example showing a method for displaying a warning according to the present embodiment. The warning unit 206 displays a warning screen 1101 on the display unit of the client PC 3. In view of the warning screen 1101, a user recognizes that the first calibration has been performed and the characteristics of the printing device have been changed. As a result, the user can perceive the need for the second calibration. The user clicks a “calibration” button 1102, thereby allowing the second calibration control unit 204 to start the second calibration processing for the second calibration. If the user determines that there is no need to perform the second calibration at that timing, the user can click an “OK” button 1103. If the “OK” button 1103 is clicked, the warning unit 206 closes the displayed warning screen 1101.

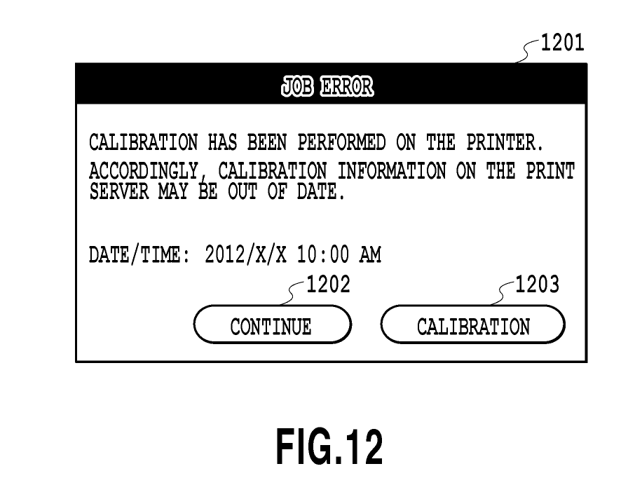

FIG. 12 illustrates another example of a warning display. In the print data processing unit 202, a job error screen 1201 is displayed upon execution of printing jobs managed by the printing device managing application if the second calibration has not been performed after receiving notification to perform the second calibration. The notification on this screen indicates that the outdated second calibration may be applied to the printing job for printing. If a “continue” button 1202 is clicked, the processing proceeds with the printing. If a “calibration” button 1203 is clicked, the printing processing is paused to move on to second calibration processing.

The above system determines on the basis of the result of the first calibration whether there is a need for the second calibration, and gives a warning to the user. With this system, inappropriate second calibration resulting from the first calibration can be prevented and notification can be given to the user to perform appropriate second calibration.

### Second Embodiment

In First Embodiment, the determining unit 307 determines from the difference between two pieces of tone density correction data as to whether there is a need for the second calibration in the print server 1. Here, notification is given only if the second calibration is determined to be necessary. The basic system configuration of the present embodiment is the same as that of First Embodiment. However, in the present embodiment, the characteristic change in the printing device 2 is determined from the difference between the previous and the current tone density correction data, and the notification is changed in accordance with the determined result.

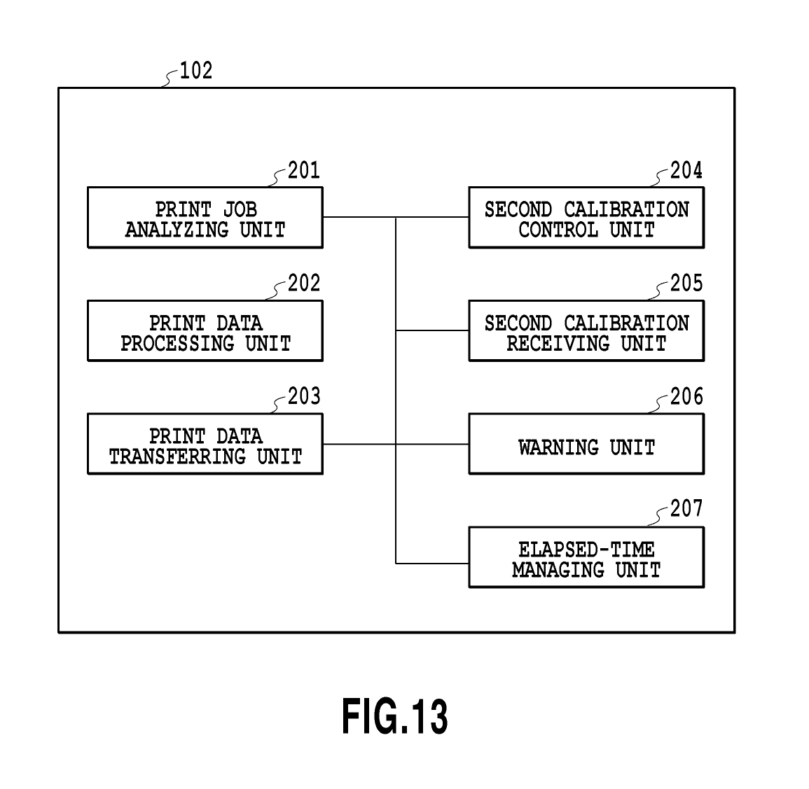

The present embodiment envisages that the print server 1 is a system for storing information about the time elapsed since the start of the second calibration and its expiration date, and for giving a warning to a user upon the expiration so that the user is prompted to perform the second calibration. To that end, as shown in FIG. 13, the print server 1 of the present embodiment also includes an elapsed-time managing unit 207. The elapsed-time managing unit 207 changes the elapsed time since the second calibration in accordance with the notification from the printing device 2.

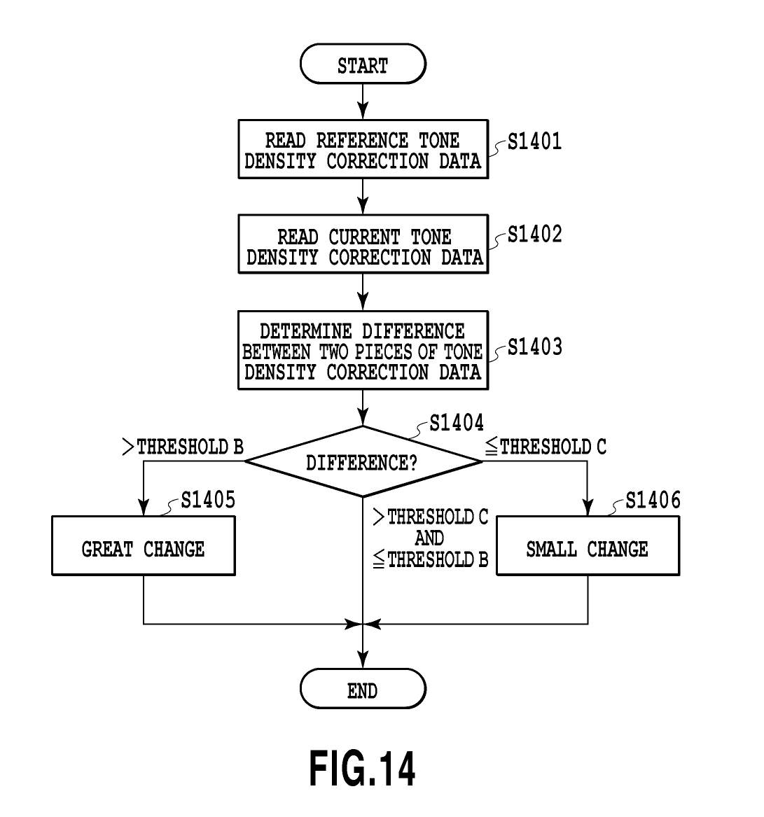

A method for determining the notification to be given to the print server 1 based on the result of the first calibration will now be described with reference to FIG. 14. FIG. 14 is a flow chart showing flow of processing to be performed by the determining unit 307 in the printing device 2.

The processing in each of steps S1401 to S1403 for reading the previous and the current tone density correction data and obtaining the difference therebetween are the same as the processing in each of steps S701 to S703 described above, and thus the description of these steps is omitted herein. In the present embodiment, the reference tone density correction data in step S1401 is the previous tone density correction data. The processing in steps 1404 to 1406 will now be described.

In step S1404, the difference obtained in step S1403 is compared with a predetermined threshold. The predetermined threshold is preset in the determining unit 307. In the present embodiment, two large and small thresholds are set which are represented herein by threshold B and threshold C, respectively.

In a case where the difference is greater than the threshold B, a great change is determined due to a great change made in the characteristics of the printing device by the first calibration. In step S1405, the printing device 2 notifies the print server 1 of the great change through the notifying unit 308.

In a case where the difference is smaller than the threshold C, a small change is determined due to almost no change made in the characteristics of the printing device by the first calibration. In step S1406, the printing device 2 notifies the print server 1 of the small change through the notifying unit 308.

In a case where the extent of the difference is larger than the threshold C and smaller than the threshold B, no notification is given due to the determination that there is no need to give notification.

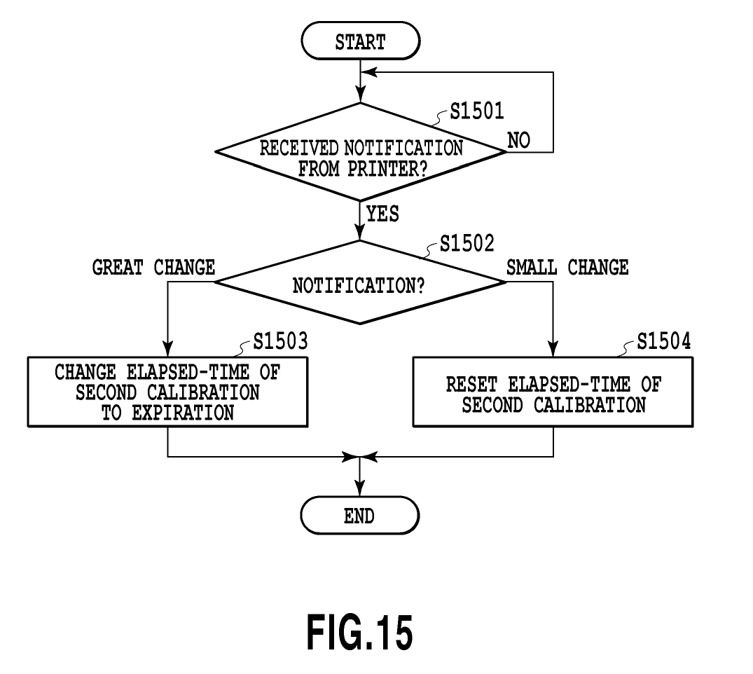

The processing of the print server 1 which has received the notification will now be described. FIG. 15 is a flow chart showing processing flow of the print server according to the present embodiment. The present processing is performed through the second calibration receiving unit 205, the warning unit 206, and the elapsed-time managing unit 207 in the print server 1.

In step S1501, it is determined whether the second calibration receiving unit 205 has received notification from the printing device 2. If determined that the notification has been received (YES in step S1501), the processing proceeds to the next step S1502.

In step S1502, the second calibration elapsed-time managing unit 207 checks the notification (received content) and changes the elapsed time since the second calibration. The information on the notification given from the printing device 2 includes two types of information which indicate great change and small change determined relative to the threshold of difference in the printing device 2.

In a case where the notification includes information about a great change, the characteristics of the printing device 2 have been greatly changed by the first calibration. Accordingly, determination can be made that correction with high accuracy is unlikely to be made with the current tone correction LUT of the second calibration. Therefore, in step S1503, the elapsed-time managing unit 207 changes the elapsed time since the second calibration to expiration of the second calibration. Upon expiration, the warning unit 206 gives a warning which prompts a user to perform the second calibration.

In a case where the notification includes information about a small change, there has been almost no change made in the characteristics of the printing device 2 by the first calibration. Accordingly, determination can be made that the current tone correction LUT of the second calibration can still be used. If determined that there is no change in the characteristics of the printing device, it can be assumed that the current tone correction LUT of the second calibration can still be used irrespective of a certain amount of time elapsed since the second calibration. In step S1504 therefore, the elapsed-time managing unit 207 resets the elapsed time since the second calibration. This means that the elapsed time since the second calibration is restored to the state immediately after the second calibration and the correction is made effective for an additional period of time.

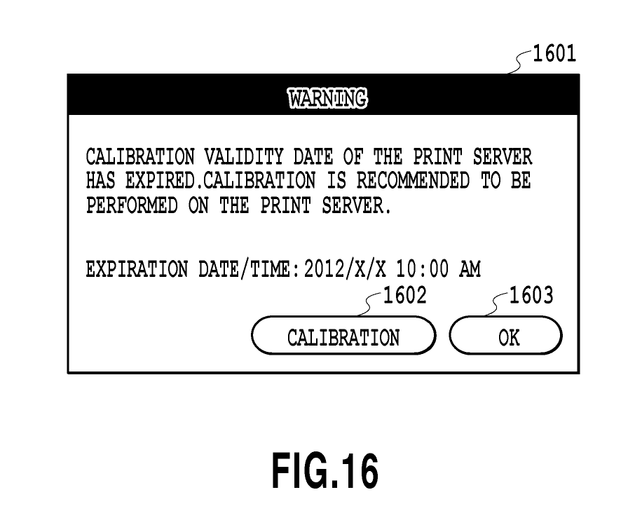

FIG. 16 illustrates an example showing a method for displaying a warning according to the present embodiment. The warning unit 206 displays a warning screen 1601 on the display unit of the client PC 3. In view of the warning screen 1601, a user can recognize that the second calibration has been expired and that there is a need to perform the second calibration. The user clicks a “calibration” button 1602, thereby allowing the second calibration control unit 204 to start the second calibration processing for the second calibration. If the user determines that there is no need to perform the second calibration at that timing, the user can click an “OK” button 1603. If the “OK” button 1603 is clicked, the warning unit 206 closes the displayed warning screen 1601.

Accordingly, a warning given to the user to perform the second calibration due to only a predetermined amount of elapsed time can be prevented if the characteristics of the printing device have not been changed and there is no need to perform the second calibration. Printing jobs cannot be usually carried out during the first and second calibration. In the production market (commercial printing market) which is required to print large quantities of materials, it is highly beneficial to reduce the frequency of unnecessary second calibration so that printing device downtime as well as consumables such as paper sheets and toners required for printing can be reduced.

The above system allows the elapsed time since the calibration performed on the print server to be changed based on the result of the calibration performed on the printing device. As a result, the calibration performed on the print server can be appropriately managed. The system also prevents a warning from being given to the user to perform calibration in a situation where the calibration is not necessary.

### Third Embodiment

In First and Second Embodiments, the first calibration in the printing device 2 is described as processing performed by the user through the processing flow shown in FIG. 4. However, the calibration performed on the printing device 2 includes other calibration which is automatically performed on the printing device 2 without following instructions from a user. It is a well-known method, for example, to form an image on an intermediate transfer member in the printing unit 115, measure a density value on a densitometer in the printing unit 115, and update tone density correction data based on the measured result.

In the present embodiment, the above calibration is referred to as third calibration. The third calibration is performed on the control unit 110 in the printing device if required. The timing for performing the third calibration is previously stored in the control unit 110 and is performed in a case where, for example, the number of printed sheets exceeds the predetermined number.

It is also a well-known method to adjust a device voltage upon image formation in the printing unit 115 based on the density value measured above. In the present embodiment, this calibration is referred to as fourth calibration. The fourth calibration is performed on the control unit 110 in the printing device 2 if required. The timing for performing the fourth calibration is previously stored in the control unit 110 and performed, for example, between predetermined printed pages. The methods for calibrating in the printing device 2 are not limited to the aforementioned first, third, and fourth calibration but different methods of calibration using different means may also be adopted.

In the present embodiment, determination is made as to whether or not notification to the print server 1 has made in accordance with the type of calibration in a case where various types of calibration have been performed on the printing device 2.

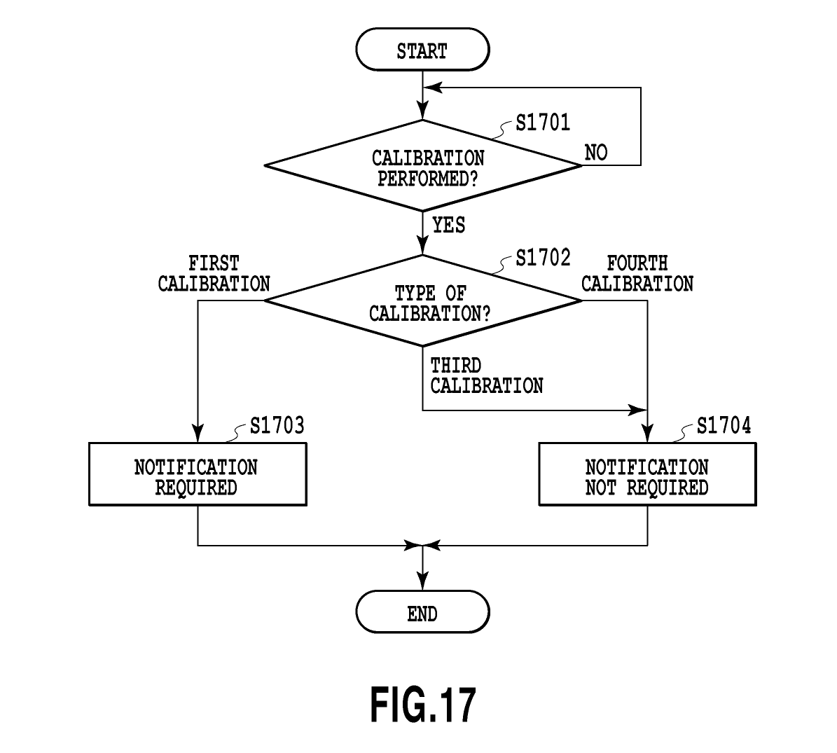

FIG. 17 is a flow chart showing processing flow carried out after calibration performed on the printing device 2 according to the present embodiment. This processing is controlled by the control unit 110 in the printing device 2. A software module is usually stored in the HDD of the control unit 110 and read out by a memory if required to be processed by the CPU.

In step S1701, the control unit 110 determines whether the calibration in the printing device 2 has been performed. If it is determined that some calibration has been performed on the printing device 2 (YES in step S1701), the processing proceeds to the next step S1702. If not (NO in step S1701), the processing returns to the top of the flow chart.

In step S1702, the control unit 110 determines the type of calibration. In a case where the type of the performed calibration is determined to be the first calibration in step S1702, the processing proceeds to step S1703. In a case where the type of the performed calibration is determined to be the third calibration or the fourth calibration in step S1702, the processing proceeds to step S1704.

In step S1703, the control unit 110 determines that there is a need for notification to the print server 1.

In step S1704, the control unit 110 determines that there is no need for notification to be given to the print server 1.

In the present embodiment, a method for giving notification for the first calibration while not giving any notification for the third and fourth calibration has been described. However, the present embodiment is not intended to be limited to this method. Whether to make notification can be determined in view of the effect on characteristic change in density in various calibration methods executed on the printing device 2. The control unit 110 gives notification to the print server 1 if required. The method for giving notification is the same as that in step S603 in First Embodiment, and thus the description of this method is omitted herein. The foregoing description of the present embodiment has been presented for the purpose of describing a method for giving notification in step S1703 in a case where the first calibration is performed. However, a need for notification can also be determined through the methods given in First and Second Embodiments.

The advantages in determining the need of notification to the print server 1 in accordance with the type of calibration will now be described. The calibration is performed to keep constant density characteristics in the engine to ensure consistent output of printed materials. However, this is not the original purpose of printing. Printing is not allowed during calibration and thus, frequent calibration may bring about a decrease in print production efficiency. In the first calibration method where a user can clearly recognize the timing for performing calibration and where the calibration is not frequently performed, it may be appropriate to display a warning to prompt the user to perform the second calibration. However, in calibration such as the fourth calibration in the present embodiment, calibration can be performed between any pages. In such a case, calibration can be more frequently performed in timing not recognized by a user. As a result, in view of the purpose of printing, it is inappropriate to display a warning to prompt a user to perform the second calibration by giving notification each time. For the above reason, it is beneficial to determine whether notification should be given in accordance with the type of calibration.

In the above system, the image processing apparatus is notified of a need for calibration therein in accordance with the type of calibration performed in the image forming apparatus. By doing so, requests to perform unnecessary calibration can be prevented. As a result, notification to prompt a user to perform the second calibration can be given at the right time without decrease in print production efficiency.

### Other Embodiments

Aspects of the present invention can also be realized by a computer of a system or apparatus (or devices such as a CPU or MPU) that reads out and executes a program recorded on a memory device to perform the functions of the above-described embodiment(s), and by a method, the steps of which are performed by a computer of a system or apparatus by, for example, reading out and executing a program recorded on a memory device to perform the functions of the above-described embodiment(s). For this purpose, the program is provided to the computer for example via a network or from a recording medium of various types serving as the memory device (e.g., computer-readable medium).

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2012-271742, filed Dec. 12, 2012, which is hereby incorporated by reference herein in its entirety.

What is claimed is:

1. An image forming apparatus having a first calibration unit configured to perform first calibration, the apparatus comprising:
a determining unit configured to determine whether second calibration is necessary in an image processing apparatus connected to the image forming apparatus by referring to the result of the first calibration; and
a notifying unit configured to send notification to the image processing apparatus to prompt a user to perform the second calibration in accordance with the determination by the determining unit.

2. The image forming apparatus according to claim 1, wherein the determining unit is configured to make determination by referring to the difference between a tone correction table obtained through the current first calibration and a reference tone correction table obtained through the previous first calibration.

3. The image forming apparatus according to claim 1, wherein the determining unit is configured to make determination by referring to the difference between the tone correction table obtained through the current first calibration and the reference tone correction table obtained through the previous first calibration where the second calibration is determined necessary.

4. The image forming apparatus according to claim 1, wherein the notifying unit is configured to:
notify the image processing apparatus of a small change in a case where determination is made by the determining unit that the difference between the tone correction table and the reference tone correction table is smaller than a predetermined value, the tone correction table being obtained through the current first calibration and the reference tone correction table being obtained through the previous first calibration where the second calibration is determined necessary; and
notify the image processing apparatus of a great change in a case where determination is made by the determining unit that the difference is larger than a predetermined value.

5. An image processing apparatus connected to an image forming apparatus for performing first calibration, the apparatus comprising:
a second calibration unit configured to perform second calibration;
an elapsed-time managing unit configured to manage an elapsed time since the start of the second calibration;
a warning unit configured to give a warning which prompts a user to perform the second calibration in accordance with the elapsed time;
a receiving unit configured to receive from the image forming apparatus, characteristic changes in the image forming apparatus determined by referring to the result of the first calibration in the image forming apparatus; and
a changing unit configured to change the elapsed time since the second calibration in accordance with the characteristic change in the image forming apparatus received at the receiving unit.

6. The image processing apparatus according to claim 5, wherein the changing unit is configured to reset the elapsed time since the second calibration in a case where the notification received at the receiving unit indicates a small change, and to change the elapsed time since the second calibration to expiration of the second calibration in a case where the notification received at the receiving unit indicates a great change.

7. A method executed in an image forming apparatus having a first calibration unit configured to perform first calibration, the method comprising:
determining whether second calibration is necessary in an image processing apparatus connected to the image forming apparatus by referring the result of the first calibration; and
sending notification to the image processing apparatus to prompt a user to perform the second calibration in accordance with the determination in the determining step.

8. A method executed in an image processing apparatus connected to an image forming apparatus for performing first calibration, the method comprising:
performing second calibration;
giving a warning which prompts a user to perform the second calibration in accordance with an elapsed time since the start of the second calibration;
receiving, from the image forming apparatus, characteristic changes in the image forming apparatus determined by referring to the result of the first calibration in the image forming apparatus; and
changing the elapsed time since the second calibration in accordance with the characteristic change in the image forming apparatus received in the receiving step.

9. A non-transitory computer readable storage medium storing a program for causing a computer to function as the image forming apparatus of claim 1.

10. A non-transitory computer readable storage medium storing a program for causing a computer to function as the image processing apparatus of claim 5.
